(19) United States
(12) Patent Application Publication
(10) Pub. No.: US 2017/0329511 A1
(43) Pub. Date: Nov. 16, 2017

(54) INPUT DEVICE, WEARABLE TERMINAL, MOBILE TERMINAL, METHOD OF CONTROLLING INPUT DEVICE, AND CONTROL PROGRAM FOR CONTROLLING OPERATION OF INPUT DEVICE

(71) Applicant: Sharp Kabushiki Kaisha, Sakai City, Osaka (JP)

(72) Inventors: MASAFUMI UENO, Sakai City (JP); TOMOHIRO KIMURA, Sakai City (JP); SHINGO YAMASHITA, Sakai City (JP); MASAKI TABATA, Sakai City (JP)

(73) Assignee: Sharp Kabushiki Kaisha, Sakai City, Osaka (JP)

(21) Appl. No.: 15/536,560

(22) PCT Filed: Sep. 30, 2015
(86) PCT No.: PCT/JP2015/077830

§ 371 Date: Jun. 15, 2017

(30) Foreign Application Priority Data
Dec. 16, 2014 (JP) 2014-254477

(51) Int. Cl. G06F 3/0488; G06F 3/0482; G06F 1/16

(52) U.S. Cl. CPC G06F 3/04883; G06F 1/163; G06F 3/0482

(57) ABSTRACT

The present invention has an object to improve operability in an input operation that involves use of two or more fingers. The present invention comprises: a detection unit (1) configured to detect a contact position of a first finger of the user on an outer edge of a casing of a terminal device (10); and a setup unit (22) configured to set up, by using as a reference a position opposite from the contact position of the first finger of the user detected by the detection unit (1), a second input area where an input made with a second finger of the user is received.

### TECHNICAL FIELD

The present invention relates to input devices for receiving user inputs on an outer edge of a casing thereof, wearable terminals including such an input device, mobile terminals including the input device, methods of controlling the input device, and control programs for controlling operation of the input device.

### BACKGROUND ART

Smart watches and other like compact wearable terminals have only a small display screen on which a touch panel is stacked. Therefore, improvement of GUI (Graphical User Interface) operability has been a large issue with these terminals. In relation to this GUI operability improvement, Patent Literature 1 discloses a GUI that improves operability by displaying radial submenus around a first touch position in a menu. The GUI also displays submenus in such a manner that a series of strokes of selecting from the submenus ends near the origin of the first stroke.

### CITATION LIST

### Patent Literature

Patent Literature 1: Japanese Unexamined Patent Application Publication, Tokukai, No. 2009-37583A (Publication Date: Feb. 19, 2009)

### SUMMARY OF INVENTION

### Technical Problem

However, the GUI disclosed in Patent Literature 1 is built basically assuming user operations with one finger (including the thumb). The GUI has problems detailed below when considering the fact that the GUI is used with a small display screen of the wearable terminal.

When the GUI disclosed in Patent Literature 1 is applied to a wearable terminal, the limited display area for opening submenus could significantly degrade visibility: for example, submenu items may need to be displayed in a small size or superimposed on the background image. In addition, submenus are opened in various directions and therefore may be hidden and made invisible by a finger, which also seriously degrades operability.

Other problems also exist. Since smart watches and other like compact wearable terminals have only a small display screen, it would be easier for the user to touch an edge of the screen or touch a side face of the casing than to touch a display item on the screen. However, if the user wearing the smart watch on the arm (or around the wrist) attempts to touch an edge of the screen or a side face of the casing with one finger, the finger will often move (displace) the terminal due to the lack of structural support for the terminal before the user can complete the touch operation.

The inventors of the present invention have diligently worked in order to solve these problems and as a result, have found that the operability of the terminal improves if two or more fingers are used, for example, by touching a side or end of the terminal with the forefinger (or a finger other than the thumb) while supporting the opposite side or end thereof with the thumb.

In view of these problems, it is an object of the present invention to provide an input or like device that improves operability in an input operation that involves use of two or more fingers.

### Solution to Problem

To address the problems, an information terminal in accordance with an aspect of the present invention is directed to an input device for receiving an input from a user on an outer edge of a casing of the input device, the input device including: a detection unit configured to detect a contact position of a first finger of the user on the outer edge; and a second setup unit configured to set up, by using as a reference a position opposite from the contact position of the first finger of the user detected by the detection unit, a second input area where an input made with a second finger of the user is received.

Additionally, to address the problems, a method of controlling an information terminal in accordance with an aspect of the present invention is directed to a method of controlling an input device for receiving an input from a user on an outer edge of a casing of the input device, the method including: (a) detecting a contact position of a first finger of the user on the outer edge; and (b) setting up, by using as a reference a position opposite from the contact position of the first finger detected in step (a), a second input area where an input made with a second finger of the user is received.

### Advantageous Effects of Invention

An aspect of the present invention can improve operability in an input operation that involves use of two or more fingers.

### BRIEF DESCRIPTION OF DRAWINGS

FIG. 1 is a block diagram of a configuration of a terminal device in accordance with an embodiment of the present invention.

Portions (a) to (d) of FIG. 2 are illustrations of variation examples of how to operate the terminal device.

Portions (a) and (b) of FIG. 3 are illustrations of variation examples of the structure of the terminal device.

Portions (a) to (d) of FIG. 4 are illustrations depicting basic operations of the terminal device.

Portions (a) to (d) of FIG. 5 are illustrations depicting operation examples in accordance with Embodiment 1 of the terminal device.

Portions (a) to (d) of FIG. 6 are illustrations depicting operation examples in accordance with Embodiment 2 of the terminal device.

Portions (a) to (d) of FIG. 7 are illustrations depicting operation examples in accordance with variation examples of Embodiment 2 of the terminal device.

Portions (a) to (c) of FIG. 8 are illustrations depicting operation examples in accordance with other variation examples of Embodiment 2 of the terminal device.

Portions (a) to (c) of FIG. 9 are illustrations depicting operation examples in accordance with Embodiment 3 of the terminal device.

Portions (a) to (c) of FIG. 10 are illustrations depicting operation examples in accordance with variation examples of Embodiment 3 of the terminal device.

Portions (a) to (c) of FIG. 11 are illustrations depicting operation examples in accordance with other variation examples of Embodiment 3 of the terminal device.

Portions (a) to (d) of FIG. 12 are illustrations depicting operation examples in accordance with further variation examples of Embodiment 3 of the terminal device.

Portions (a) to (d) of FIG. 13 are illustrations depicting operation examples in accordance with still other variation examples of Embodiment 3 of the terminal device.

Portions (a) to (d) of FIG. 14 are illustrations depicting operation examples in accordance with Embodiment 4 of the terminal device.

FIG. 15 is a drawing of variation examples of display items in display menus for the terminal device.

FIG. 16 is a drawing of other variation examples of display items in display menus for the terminal device.

### DESCRIPTION OF EMBODIMENTS

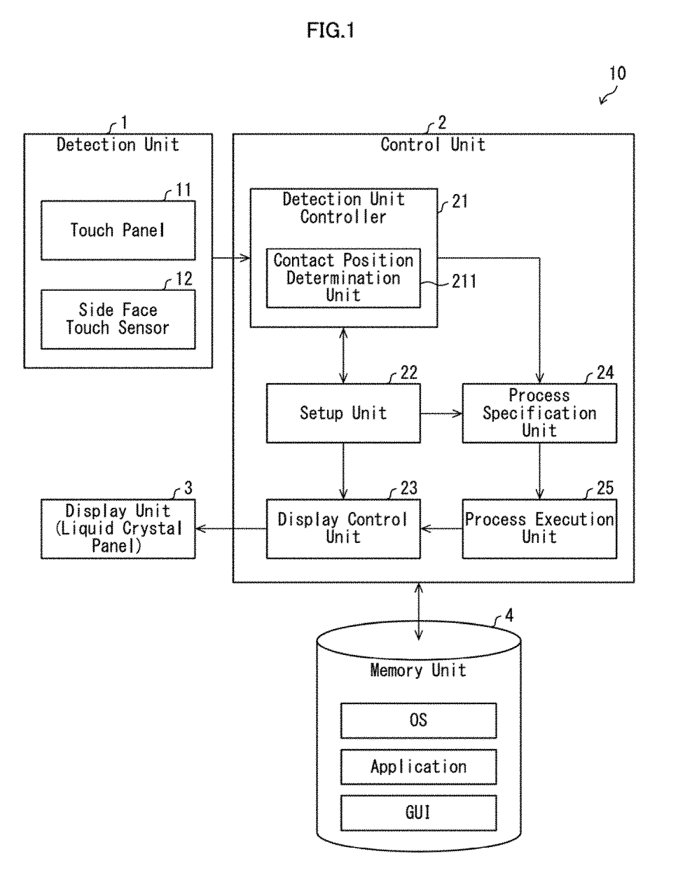

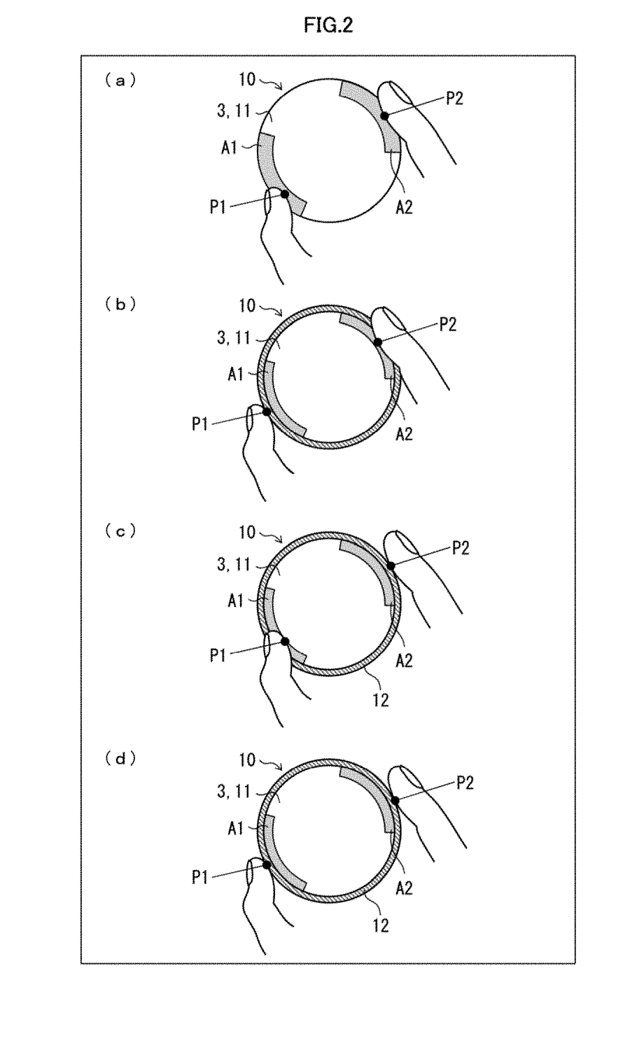

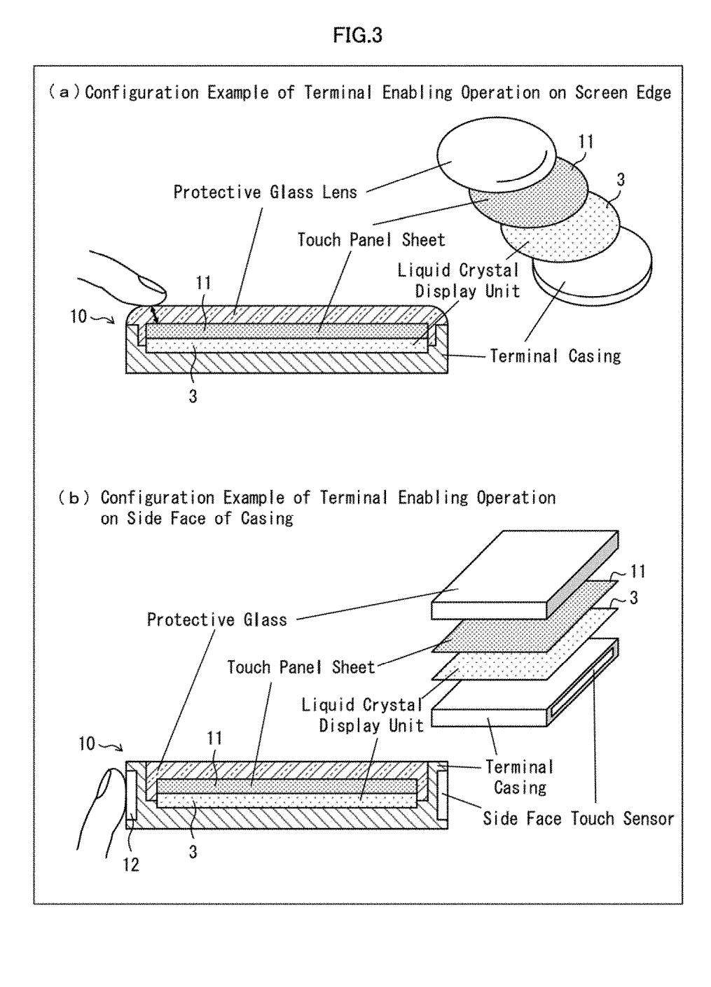

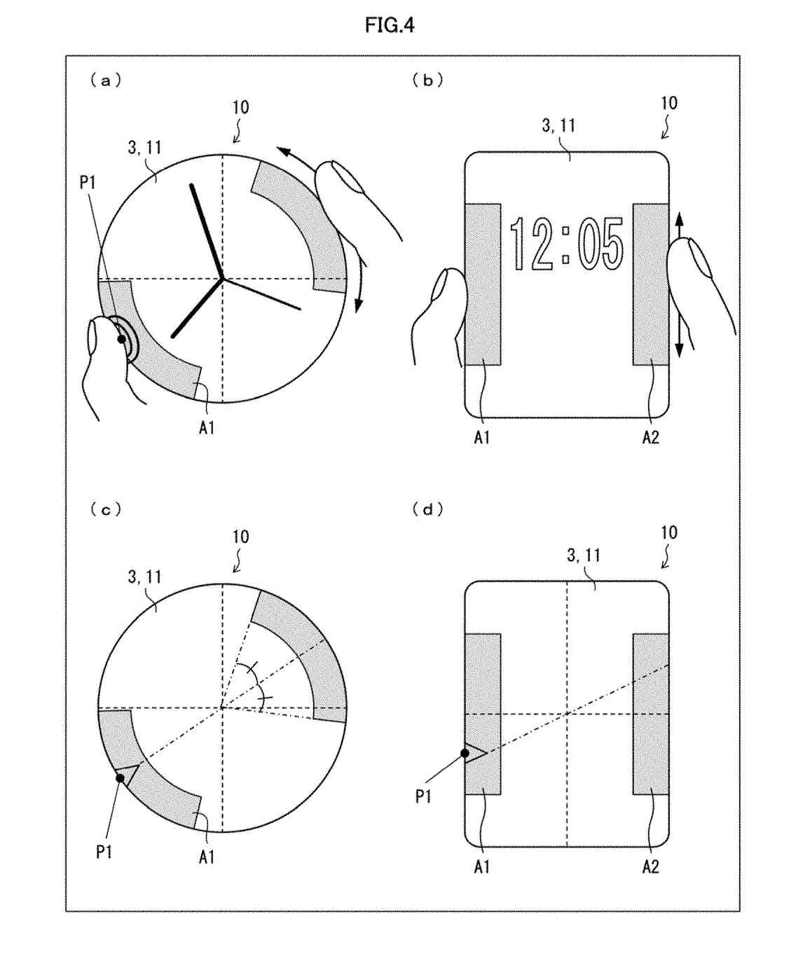

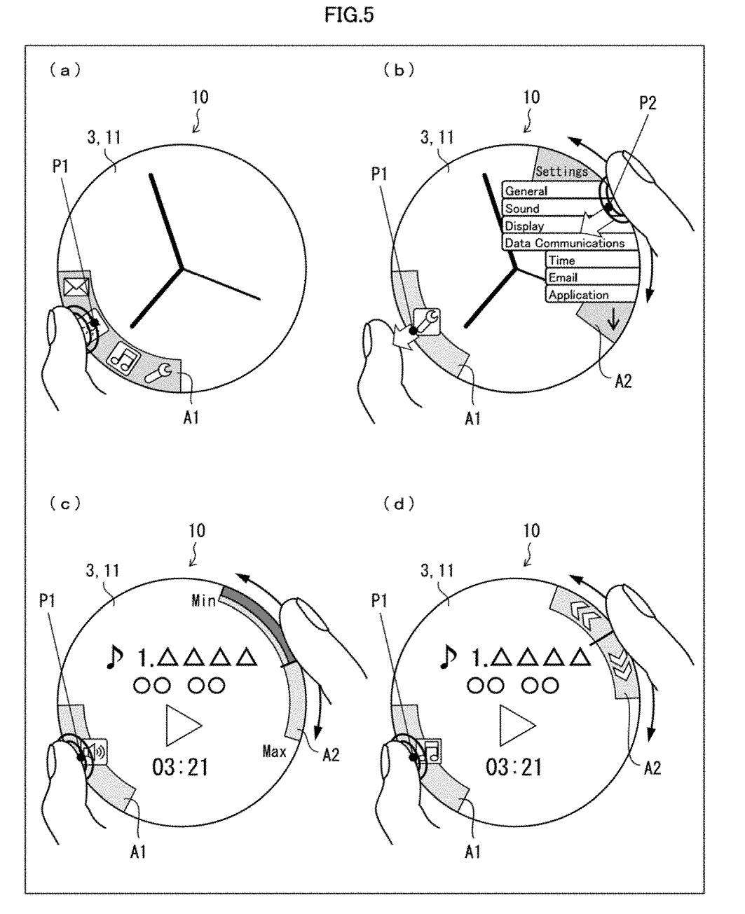

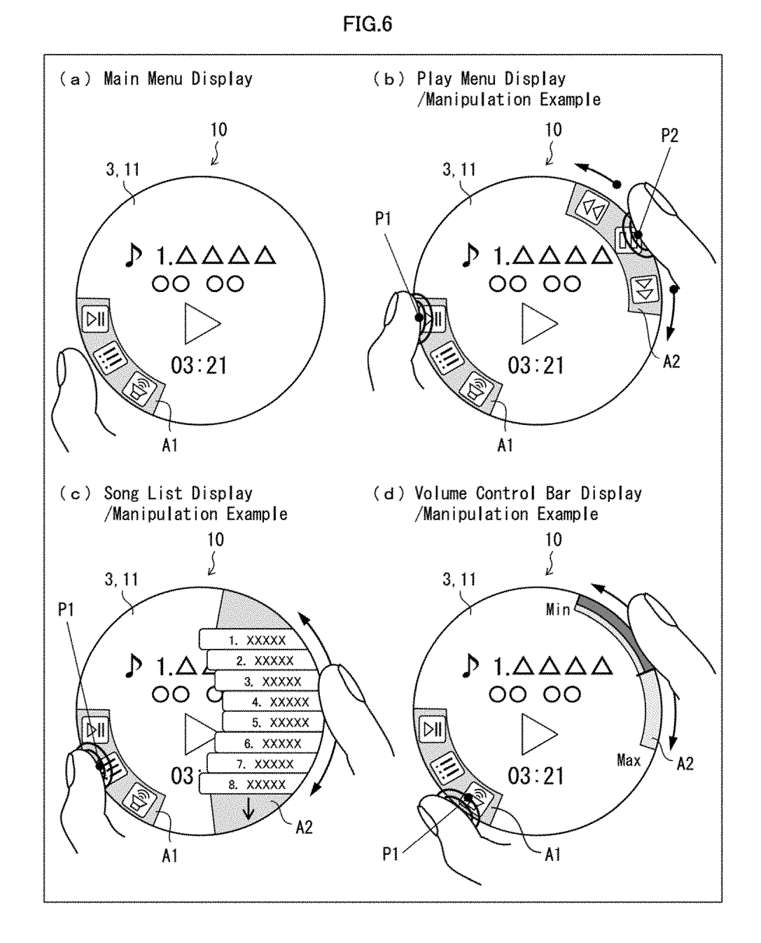

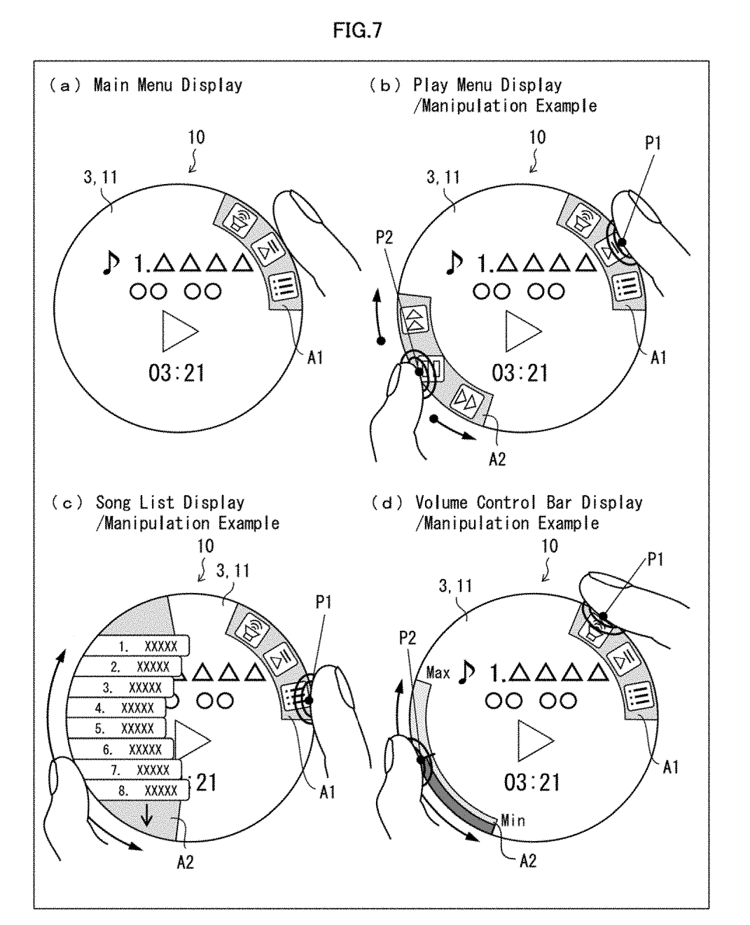

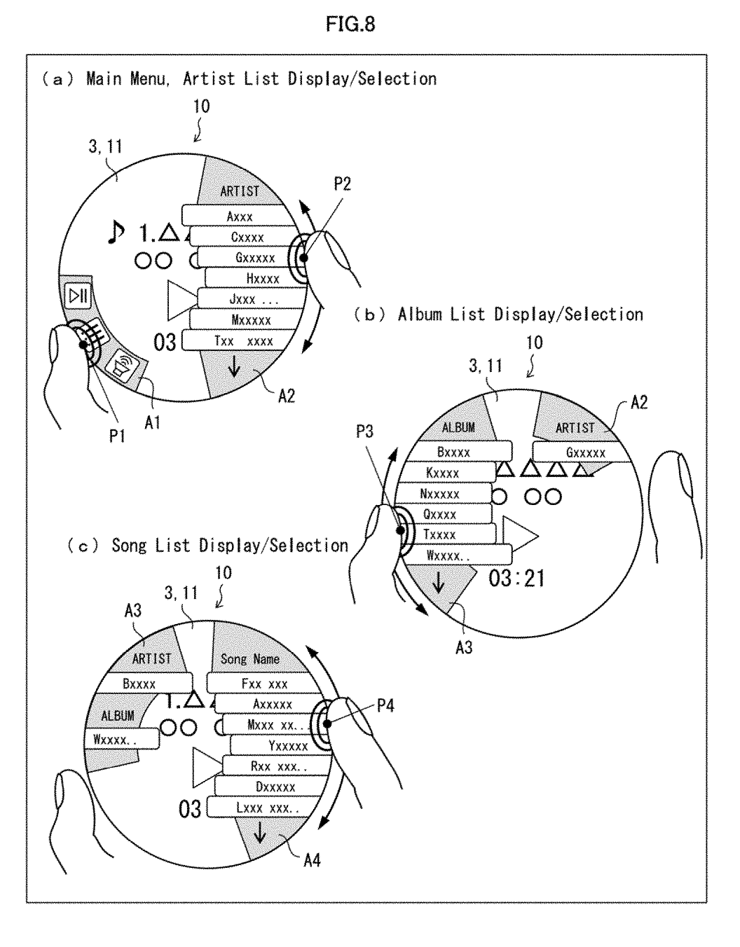

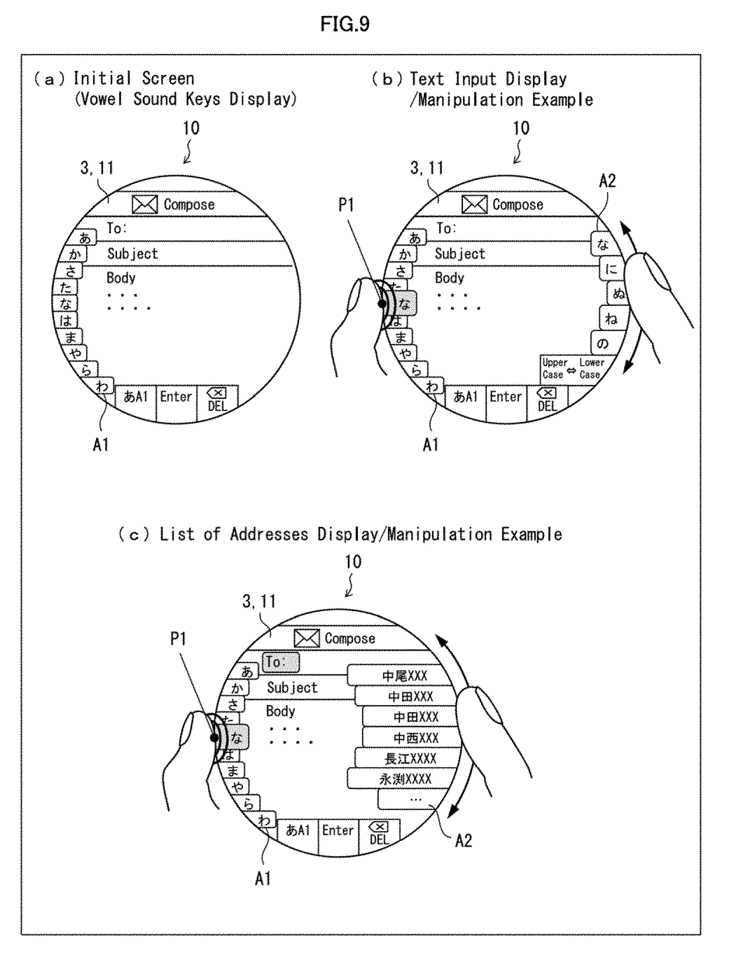

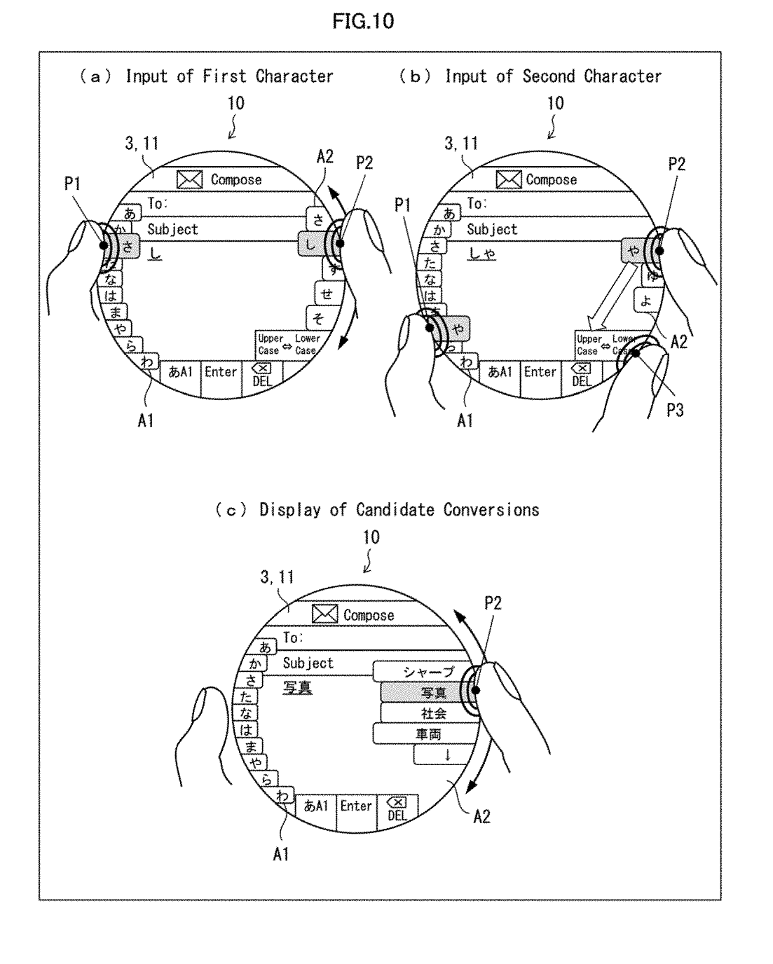

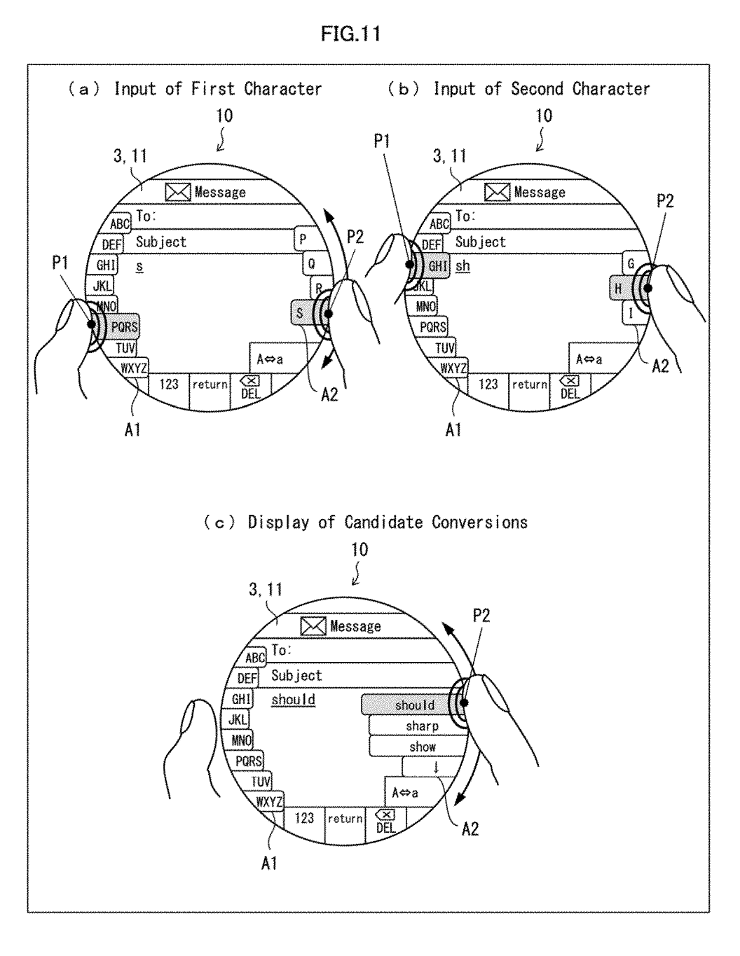

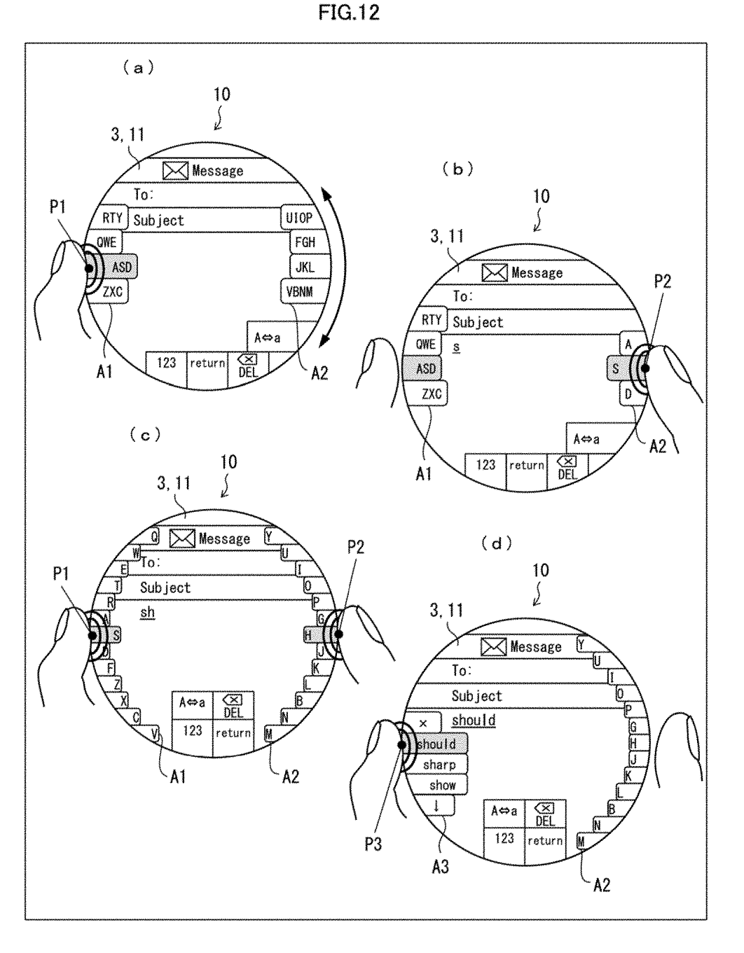

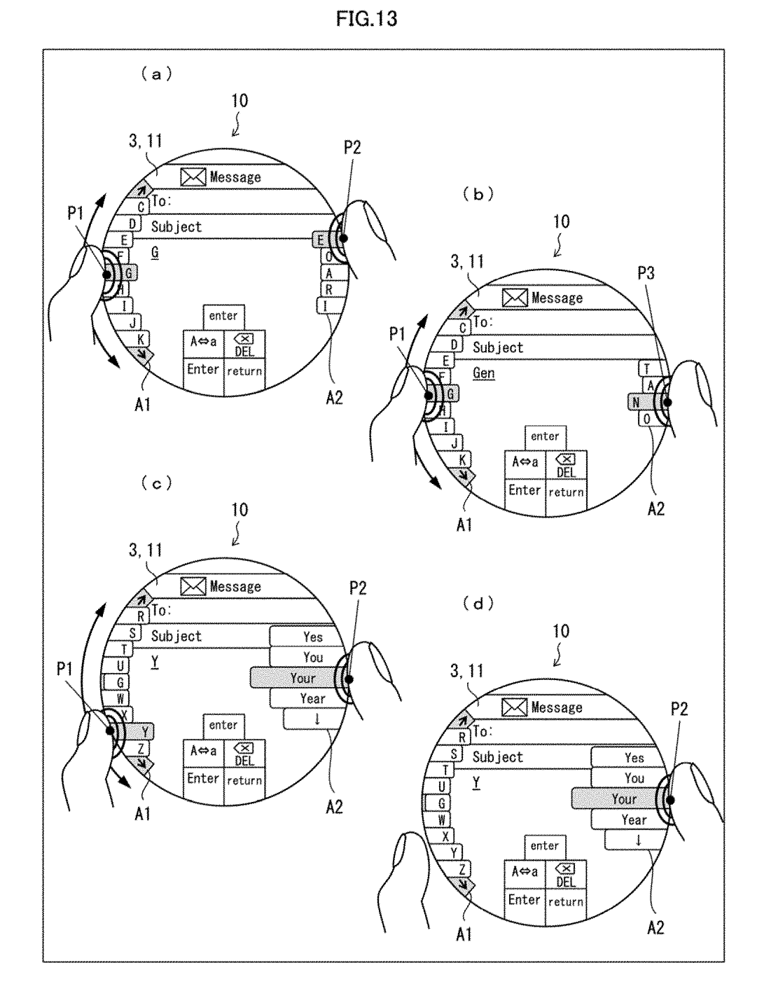

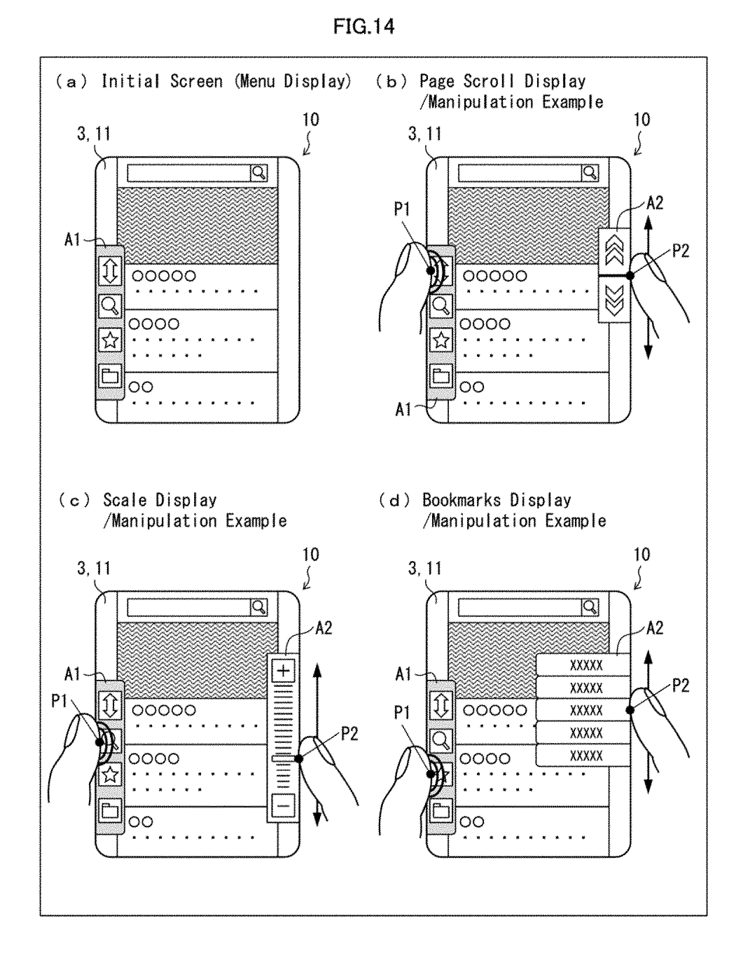

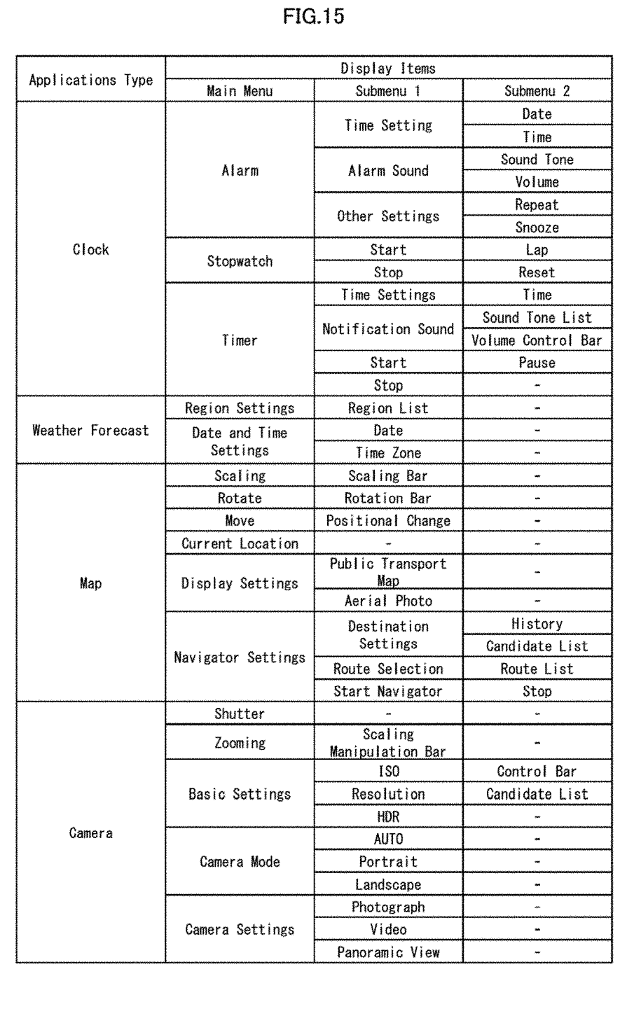

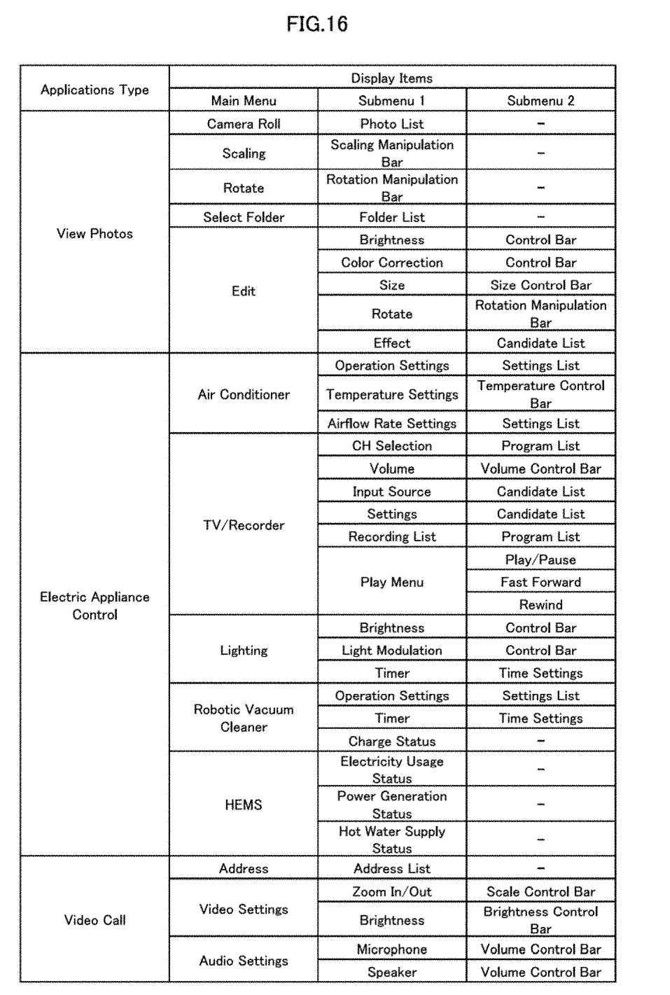

The following will describe embodiments of the present invention in reference to FIGS. 1 to 16. Throughout the following, members of an embodiment that have the same arrangement and function as members of another embodiment are indicated by the same reference numerals, and description thereof may be omitted for convenience of description.

### Configuration of Terminal Device 10

The configuration of a terminal device (input device, wearable terminal, or mobile terminal) 10 in accordance with embodiments of the present invention will be described in reference to FIG. 1. FIG. 1 is a block diagram of the configuration of the terminal device 10. The terminal device 10 of the present embodiment, as will be described later in detail, has a function of receiving user inputs on an outer edge of a casing (particularly, a display unit 3) thereof. The terminal device 10 is by no means limited to a wearable terminal such as a clock and may be a mobile terminal such as a smart phone or a terminal placed on a table or a wall. The present invention may be embodied in the form of a control device such as volume controls on audio equipment, as well as in the forms of information terminals including the wearable terminals, mobile terminals, and portable terminals described here. The terminal device 10 is not necessarily as small in size as a clock (screen size: approximately 2 inches) and only needs to be sufficiently large in size so that both ends (or sides) of the casing (or of the display unit 3) can be simultaneously touched with two fingers of a hand (screen size: approximately 5 inches). Referring to FIG. 1, the terminal device 10 includes a detection unit 1, a control unit 2, the display unit 3, and a memory unit 4.

### Detection Unit 1

In the present embodiment, the detection unit 1 includes a touch panel (detection unit) 11 and a side face touch sensor (detection unit) 12. The touch panel 11 is stacked on the display unit 3. The side face touch sensor 12 is disposed on a side face on the outer edge of the display unit 3 provided in the casing of the terminal device 10.

The touch panel 11 is configured to detect a target object touching or approaching a display screen of the display unit 3 in the casing and also to detect a first or a second finger touching or approaching the outer edge of the casing (or the display unit 3) (detection step). This configuration enables the touch panel 11, which is stacked on the display unit 3 in the casing and which also detects a target object touching or approaching the display screen of the display unit 3, to detect a first or a second finger touching or approaching the outer edge of the casing (or the display unit 3). Therefore, no new detection member needs to be provided to detect touching or approaching of the outer edge of the casing (or the display unit 3). That in turn can reduce the parts count.

Meanwhile, the side face touch sensor 12 is configured to detect a first or a second finger touching or approaching a side face of the casing. This configuration enables the side face touch sensor 12, disposed on a side face of the casing of the terminal device 10, to detect the first or the second finger touching or approaching the outer edge of the casing.

The detection unit 1 (touch device) may be provided in any form including the touch panel 11 and the side face touch sensor 12, provided that a touch can be detected on a side (corner) of a display device in the display unit 3 or on a side face of the casing of the terminal device 10.

### Control Unit 2

The control unit 2, built around, for example, a CPU (central processing unit), collectively controls each unit in the terminal device 10. Referring to FIG. 1, the control unit 2 includes a detection unit controller 21, a setup unit (a first and a second setup unit) 22, a display control unit 23, a process specification unit 24, and a process execution unit 25.

### Detection Unit Controller 21

The detection unit controller 21 includes a contact position determination unit 221 to determine the location of a target object on the display screen of the display unit 3 (the “contact position”; e.g., coordinates) by means of the touch panel 11 based on a result of detection of the target object touching or approaching the display screen. The contact position determination unit 221 in the detection unit controller 21 is configured to determine the contact position (coordinates) of the target object on the outer edge of the display unit 3 based on a result of the detection by the touch panel 11 of the first or the second finger touching or approaching the outer edge of the display unit 3.

The detection unit controller 21 is configured to determine the contact position of the target object on the side face touch sensor 12 based on a result of the detection of contact or approach of the target object by the side face touch sensor 12. The contact position determination unit 221 is configured to provide the setup unit 22 and/or the process specification unit 24 with information on the contact position of the target object in the determined display screen or information on the contact position of the target object as provided by the side face touch sensor 12.

### Setup Unit 22

The setup unit 22 is configured to set up, in or proximate to the contact position of the first finger detected by the detection unit 1, a first input area where an input with the first finger is received. The setup unit 22 is further configured to set up a second input area where an input with the user's second finger is received, using a position opposite from the contact position of the first finger detected by the detection unit 1 as a reference (second setup step). This configuration results in the second input area for the second finger being set up across from the contact position of the user's first finger where the first finger has touched the outer edge of the display unit 3, which can improve operability in an input operation that involves use of two or more fingers. The configuration also enables reception of an input that involves use of the first finger as well as an input that involves use of the second finger, which enables reception of more than one input. The setup unit 22 is configured to provide the detection unit controller 21, the display control unit 23, and/or the process specification unit 24 with information on the first input area and the second input area that have been set up.

The setup unit 22 may set up the first input area if the detection unit 1 has detected the contact position of the first finger and subsequently detected the contact position of the second finger and set up the second input area if the detection unit 1 has detected the contact position of the second finger and subsequently detected the contact position of the first finger, and the detection unit 1 may alternately detect the contact position of the first finger and the contact position of the second finger, so that the setup unit 22 can alternately set up the first input area and the second input area. According to this configuration, the first input area and the second input area are alternately set up if an input is made alternately with the first finger and with the second finger, which can improve operability in an input operation that involves use of two or more fingers.

### Display Control Unit 23

The display control unit 23 controls the display unit 3 to display predetermined and other images (for example, a main menu, submenus, and icons in each menu (menu items) that will be described later in detail). Particularly, the display control unit 23 of the present embodiment is configured to control the display unit 3 to display, in or near the first input area on the display unit 3, a main menu as a first input-use image that prompts the user to make an input in the first input area with the first finger. According to this configuration, the first input-use image is displayed in or near the first input area. That in turn enables the user to visually recognize the first input-use image (main menu) so that the user can make an input in the first input area while visually recognizing that image.

The display control unit 23 is configured to control the display unit 3 to display, in or near the second input area on the display unit 3, a submenu as a second input-use image that prompts the user to make an input in the second input area with the second finger. According to this configuration, a submenu is displayed in or near the second input area, which is triggered by the input in the first input area with the first finger as prompted by the main menu. That in turn enables the user to visually recognize the submenu upon that input so that the user can make an input in the second input area while visually recognizing the submenu, which can improve the visibility of the menus on the display screen and the operability of the terminal device 10.

The submenu is not displayed in or near the second input area until an input is made in the first input area. Therefore, the user cannot recognize the presence of the second input area before making an input in the first input area. In other words, the user cannot make an input in the second input area before making an input in the first input area. Thus, no input is allowed in the second input area while the user is making an input in the first input area. The configuration can hence prevent malfunctions that could be caused if inputs are permitted in more than one location.

Alternatively, the display control unit 23 may display the first input-use image if the detection unit 1 has detected the contact position of the first finger and subsequently detected the contact position of the second finger, display the second input-use image if the detection unit 1 has detected the contact position of the second finger and subsequently detected the contact position of the first finger, and alternately display the first input-use image and the second input-use image if the detection unit 1 has alternately detected the contact position of the first finger and the contact position of the second finger. According to this configuration, the first input-use image and the second input-use image are alternately displayed if an input is made alternately with the first finger and with the second finger. That in turn enables the user to visually recognize the first input-use image and the second input-use image alternately upon such inputs so that the user can make an input alternately in the first input area and in the second input area while visually recognizing those images, which can improve operability in an input operation that involves use of two or more fingers.

As a further alternative, the display control unit 23 may display hierarchically lower-level submenus in accordance with the sequence in which the first input-use image and the second input-use image are alternately displayed. This configuration enables selection of menu items in hierarchically lower-level submenus in accordance with the sequence in which the first input-use image and the second input-use image are alternately displayed, which can improve operability in an input operation that involves use of two or more fingers.

### Process Specification Unit 24

The process specification unit 24 is configured to specify the processing to be executed that corresponds to the input operations by the user based on information on the inputs in the first and second input areas set up by the setup unit 22 and either information on the contact position of the target object in the display screen as determined by the contact position determination unit 221 in the detection unit controller 21 or information on the contact position of the target object as provided by the side face touch sensor 12. The process specification unit 24 is further configured to provide the process execution unit 25 with information on the specified processing.

### Process Execution Unit 25

The process execution unit 25 is configured to cause an appropriate block (particularly, the display control unit 23) in the control unit 2 to execute a process in accordance with the specified processing based on the information on the processing received from the process specification unit 24.

### Display Unit 3

The display unit 3 of the present embodiment includes, for example, a liquid crystal panel as a predetermined display screen to display images. The display panel used in the display unit 3 is by no means limited to a liquid crystal panel and may be an organic EL (electroluminescence) panel, an inorganic EL panel, or a plasma panel.

The display unit 3 of the present embodiment is configured to display, particularly in or near the first input area, the main menu as the first input-use image that prompts the user to make an input in the first input area with the first finger. The display unit 3 is further configured to display, in or near the second input area, a submenu as the second input-use image that prompts the user to make an input in the second input area with the second finger.

The present embodiment has so far described the terminal device 10 including the display unit 3. The present invention is not necessarily embodied in this form that includes a display unit. For example, the present invention may be embodied, without there being the display unit 3, in the form of an input or control device that only receives touch operations on the outer edge of the casing.

### Memory Unit 4

The memory unit 4 prestores various information required for the operation of all the units in the control unit 2 and also stores various information generated by the units during the operation of the terminal device 10 on the fly. Examples of the information prestored in the memory unit 4 include information on the OS (operating system), which is basic software to operate the terminal device 10, information on various applications (software), and information on the GUI (graphical user interface) produced on the display unit 3.

Examples of the various information generated by the units during the operation of the terminal device 10 include information on the contact position of the first or the second finger determined by the contact position determination unit 221 in the detection unit controller 21, information on the first or the second input area set up by the setup unit 22, and information on the first input-use image (main menu image) or the second input image (submenu image) generated by the display control unit 23.

### Variation Examples of Operation of Terminal Device 10

Next, referring to FIG. 2, variation examples of the operation of the terminal device 10 will be described. The description here will focus on four variation examples of the operation of the terminal device 10. The present invention is not necessarily embodied in the forms of these four variation examples and may be embodied in any form, provided that a touch can be detected on a side (corner) of the display device or a side face of the casing.

Portion (a) of FIG. 2 shows a mode in which both the first input area and the second input area are located on the periphery of the display screen of the touch panel. In this mode, the locations of the first input area and the second input area are matched with the display positions of the first input-use image (main menu) and the second input-use image (submenu). In this mode, if the user touches with the thumb (first finger) a contact position P1 in a first menu (main menu) being displayed in an area A1 on the touch panel, the second input-use image (submenu) is displayed in an area A2 on the touch panel. Also in this mode, the user can make an input in the submenu by touching with the forefinger (second finger) a contact position P2 in the submenu being displayed in the area A2 on the touch panel.

Portions (b) and (c) of FIG. 2 show modes in which one of the first input area and the second input area is located on the periphery of the display screen of the touch panel whilst the other input area is located on the side face touch sensor 12 disposed on a peripheral side face of the casing. The side face touch sensor 12 is preferably disposed stretching all along the peripheral side face of the casing of the terminal device 10 as shown in these figures.

Portion (b) of FIG. 2 shows a mode in which the first input area is located on the side face touch sensor 12 whilst the second input area is located on the periphery of the display screen of the touch panel. In this mode, if the user touches with the thumb the contact position P1 on the side face touch sensor 12 near the first menu being displayed in the area A1 on the touch panel, the second input-use image (submenu) is displayed in the area A2 on the touch panel. Also in this mode, the user can make an input in the submenu by touching with the forefinger the contact position P2 in the submenu being displayed in the area A2 on the touch panel.

In contrast, portion (c) of FIG. 2 shows a mode in which the first input area is located on the periphery of the display screen of the touch panel whilst the second input area is located on the side face touch sensor 12. In this mode, if the user touches with the thumb the contact position P1 in the first menu being displayed in the area A1 on the touch panel, the second input-use image (submenu) is displayed in the area A2 on the touch panel. Also in this mode, the user can make an input in the submenu by touching with the forefinger the contact position P2 on the side face touch sensor 12 near the submenu being displayed in the area A2 on the touch panel.

Next, portion (d) of FIG. 2 shows a mode in which both the first input area and the second input area are located on the side face touch sensor 12 disposed on a peripheral side face of the casing. In this mode, if the user touches with the thumb the contact position P1 on the side face touch sensor 12 near the first menu being displayed in the area A1 on the touch panel, the second input-use image (submenu) is displayed in the area A2 on the touch panel. Also in this mode, the user can make an input in the submenu by touching with the forefinger the contact position P2 on the side face touch sensor 12 near the submenu being displayed in the area A2 on the touch panel.

### Variation Examples of Structure of Terminal Device 10

Next, referring to FIG. 3, variation examples of the structure of the terminal device 10 will be described. The description here will focus on configuration examples of a clock or like wearable information terminal. Portion (a) of FIG. 3 shows a configuration example in which a touch operation on an edge of the screen of the display unit 3 is enabled. The mode includes a narrow-framed touch panel sheet (touch panel 11) and a protective glass for the terminal. The glass is shaped to project out of the front face of the casing so that the touch panel 11 can respond also to a touch on the edge of the screen (corner of the protective glass). Also in this mode, the protective glass has lensing effects so that video display can be expanded to the peripheral part of the terminal. A manipulation-use image displayed along the peripheral part of the screen in this configuration will enable the user to directly touch the operation screen for operation. The touch panel 11 includes sensors that cover almost up to the peripheral part of the casing, thereby enabling a touch operation on the peripheral part (edges and corners) of the terminal.

Portion (b) of FIG. 3 shows a configuration example in which a touch operation on a side face of the casing of the terminal device 10 is enabled. The mode includes the side face touch sensor 12 on a side face of the casing independently from the touch panel 11. The side face touch sensor 12 is one-dimensional in the height direction of the screen and capable of determining which part of the side face is touched by the user. Portions (a) and (b) of FIG. 3 show a casing with a circular cross-section and a casing with a rectangular cross-section respectively. The casing may be circular in cross section and have a side face touch sensor provided on a side face thereof and may be rectangular in cross section and enabled for touch operation on the edge of the screen. In addition, in the mode shown in portion (b) of FIG. 3, only two opposite sides of the rectangle are equipped with a side face touch sensor. Alternatively, all the four sides of the rectangle may be equipped with a side face touch sensor.

### Basic Operations of Terminal Device 10

Next, referring to FIG. 4, the basic operations of the terminal device 10 will be described. Portion (a) of FIG. 4 shows a mode in which the terminal device 10 includes a casing with a circular cross-section. Portion (b) of FIG. 4 shows a mode in which the terminal device 10 includes a casing with a rectangular cross-section. In the basic operations of the terminal device 10, as shown in portions (a) and (b) of FIG. 4, if the user makes a first touch in the contact position P1 in the area A1 with the thumb (first finger), an associated submenu (second input-use image) is displayed in the area A2 by using the position opposite from the contact position as a reference. More specifically, for example, when a “Music Playing” screen is being displayed, “Select Song,” “Play Menu”, “Volume”, and “Select Other Apps” are displayed as the main menu (first input-use image) near the first touch position. If any one of these items is selected by the first touch, a submenu related to the first selection is displayed in a submenu area opposite from the main menu. If “Play Menu” is selected in the main menu, a submenu is displayed that includes “Rewind,” “Pause,” and “Fast Forward” icons (buttons or menu items) for selection. Furthermore, if “Volume” is selected first in the main menu, a submenu is displayed that includes a volume indicator so that the user can slide over the indicator for volume control.

The main menu may be displayed either close to where a touch has been made on the outer edge of the display unit 3 with the thumb (first finger) in response to that touch or close to where a touch is expected to be made with the thumb since before the touch is actually made. The following modes (1) and (2) are given here as more specific examples.

(1) Upon starting an application, the main menu is displayed in a peripheral part of the screen of the display unit 3 (since before the thumb touches). The main menu in the peripheral part of the screen disappears when the central part of the screen (the area of the screen where the menu is not being displayed) is touched. After that, the main menu is displayed close to where a touch is made on the outer edge of the display unit 3, in response to that touch.
(2) No main menu is displayed upon the start of an application. The main menu is displayed close to where a touch is made on the outer edge of the display unit 3, in response to that touch.

Portions (c) and (d) of FIG. 4 show modes in which a submenu is displayed near a position (location of the area A2) across the central part of the screen from the first touch position (contact position P1). The submenu however does not need to be displayed strictly in such a position.

The modes shown in FIG. 4 are directed to touch operations and user interfaces that improve touch operability and screen visibility in clocks and other like compact input devices.

The compact input device has a limited screen display area. Operability and visibility of the compact input device will improve, for example, if the operation command menu is displayed on a peripheral part of the screen so that the user can touch the edge of the screen and the side face of the casing for operation. For example, if two or more operation buttons are to be displayed in the central part of the screen, the buttons need to be displayed in small size, which can lead to poor visibility and wrong touches. The screen may be partially hidden and made invisible by the finger being used in the operation.

If the user wears, for example, a clock on the wrist and attempts to operate the compact input device on an edge/side face thereof, the user cannot readily touch or press the edge/side face with one finger without displacing the casing. The user would find it easier to support the casing with one finger and operate the input device with another finger. However, the input device would interpret this operation that involves use of two fingers as two touches at different points and might fail to determine which of the touches should be interpreted as an input operation, possibly resulting in a malfunction. For these reasons, as mentioned above, the submenu related to the touch (that gives support to the terminal) by which the first main menu is selected is displayed near the position opposite from the position where the first touch has been made, to enable the user to readily perform delicate operations with another finger. This manner of operation restrains wrong operations that involve use of two fingers and simultaneously improves operability and visibility.

### Embodiment 1: Operation Example 1 for Terminal Device 10

Operation examples for the terminal device 10 in accordance with Embodiment 1 will be described in reference to FIG. 5. Portions (a) and (b) of FIG. 5 show an example of basic touch operations on an edge of the screen or side faces of the casing of the terminal device 10. The user can select a menu item from a menu displayed on a peripheral part of the screen or operate the menu by a combination of these basic touch operations.

Portions (a) and (b) of FIG. 5 show an operation example in which the user can select one of items for operation from a displayed menu. In an example of selecting an item from a main menu displayed in the area A1 shown in portion (a) of FIG. 5, if the user selects a main menu item by, for example, a “single tapping (brief touch and release)” or a “press and hold” in the contact position P1 with the thumb, an associated submenu is displayed in the area A2 as shown in portion (b) of FIG. 5 by using the position opposite from the contact position P1 as a reference.

The example in portion (b) of FIG. 5 shows a submenu associated with a main menu item, “Settings,” being displayed in the area A2 after the “Settings” main menu item is selected in the main menu displayed in the area A1.

The user can select an item in a submenu by, for example, a “single tapping (brief touch and release)” or “touch, slide, and release for selection”. When there are many items (e.g., a long list of items) in a menu, the user needs to scroll the menu. To distinguish this scroll operation from a single tapping and a “touch and release for selection” operation, the user can perform, for example, a “double tapping,” a “touch and swipe in toward the center of the screen,” or a “release touching thumb for selection of item being touched on with forefinger” operation.

Portions (c) and (d) of FIG. 5 show modes in which the user can slide a finger on the edge to select an item in the displayed submenu (the user touches a cursor on the indicator and then slides for adjustment).

This example in portion (c) of FIG. 5 shows a mode in which the user can slide on the indicator in a submenu to move (slide operation) for volume control. In this mode, motion is made in accordance with the direction of the sliding and the distance by which the finger is slid from the first touch position in the area A2. The example in portion (c) of FIG. 5 shows a mode related to volume control. The same action of sliding on the indicator in the submenu for motion may be used in other modes, for example, to scale up/down an image (scale adjustment)

The example in portion (d) of FIG. 5 shows a mode in which the display is changed sequentially in accordance with the direction of motion from the first touch position in the area A2 (e.g., screen scrolling, switching to next/previous page, fast forward/rewind, cursor motion, and image resizing). For example, the screen may be scrolled (scroll operation) downward on the paper showing the figure in response to clockwise sliding started at the first touch position in the submenu and may be scrolled at different speeds depending on the distance of the finger motion.

### Effects

In clocks and like compact input devices, each of these modes displays an associated submenu across from the first touch select position so that the user can support the casing with one finger and perform delicate touch operations with another finger, thereby improving operability. In compact input devices with limited display content, these modes display operation menus on the periphery of the screen, thereby also improving screen visibility.

### Embodiment 2: Operation Example 2 for Terminal Device 10

Operation examples for the terminal device 10 in accordance with Embodiment 2 will be described in reference to FIGS. 6 to 8. FIG. 6 shows an operation example of a music player application. Portion (a) of FIG. 6 shows the terminal device 10 displaying a main menu near the first touch position. Portion (a) of FIG. 6 shows a mode in which, for example, “Play Menu,” “Select Song,” and “Volume” icons are displayed as part of a main menu near the lower left side of the display unit 3 on the paper showing the figure and when touched, respectively invoke associated submenus across from the main menu.

Portion (b) of FIG. 6 shows the terminal device 10 either displaying the “Play Menu” or responding to the user's subsequent actions. The “Play Menu” includes “Pause” and “Fast Forward/Rewind” icons (buttons or menu items). To fast forward/rewind, the user slides the finger starting at the first touch position and moving in the directions indicated by arrows, for sequential (contiguous) fast forwarding/rewinding. The speed of the fast forwarding/rewinding may be increased in accordance with the distance by which the finger is slid.

Portion (c) of FIG. 6 shows the terminal device 10 either displaying a song list or responding to the user's subsequent actions. The “Select Song” includes a list of songs (menu items) so that the user can select a song by touching one of the menu items. Alternatively, the user can select a song displayed where he/she has released the finger after touching and sliding. The terminal device 10 may also be configured so that sliding the finger out of the list invokes a display of a next page.

Portion (d) of FIG. 6 shows the terminal device 10 either displaying a volume control bar or responding to the user's subsequent actions. Selecting the “Volume” icon in the main menu invokes a display of a volume indicator in the area A2 so that the user can control sound volume by sliding the cursor indicating the current volume level.

FIG. 7 shows another operation example of the music player application. Portion (a) of FIG. 7 shows the terminal device 10 displaying a main menu. Portion (b) of FIG. 7 shows the terminal device 10 displaying the “Play Menu” or responding to the user's subsequent actions. Portion (c) of FIG. 7 shows the terminal device 10 displaying a song list or responding to the user's subsequent actions. Portion (d) of FIG. 7 shows the terminal device 10 displaying a volume control bar or responding to the user's subsequent actions.

In the mode shown in FIG. 6, as an example, the main menu is displayed in the lower left side of the screen so that the user can manipulate the main menu with the thumb. Alternatively, as in the mode shown in FIG. 7, the main menu may be displayed in the upper right side of the screen so that the user can manipulate the main menu with the forefinger (first finger) and touch a submenu with the thumb (second finger), in which case the forefinger supports the terminal device 10 (supporting point) whilst the thumb slides over the edge. The main menu, if not displayed initially, may be displayed later near the first touch location on the edge. Alternatively, the main menu may be displayed beforehand on the top or bottom of the screen.

FIG. 8 shows a further operation example of the music player application. FIG. 8 shows an exemplary mode in which a song is selected from a displayed list organized in multiple hierarchical levels including “Artist,” “Album,” and “Song Title” among others. Portion (a) of FIG. 8 shows the terminal device 10 displaying an artist list or responding to the user's subsequent actions. Portion (b) of FIG. 8 shows the terminal device 10 displaying an album list or responding to the user's subsequent actions. Portion (c) of FIG. 8 shows the terminal device 10 displaying a song title list or responding to the user's subsequent actions.

Touching a song select icon in the main menu, for example, in the area A1 (contact position P1) with the thumb (first finger) invokes a display of a list of artists in a peripheral part of the screen opposite from the contact position P1 (area A2 or contact position P2), thereby enabling selection with another finger (second finger). Selecting from the list of artists in the area A2 (contact position P2) invokes a display of a list of albums of the selected artist in a peripheral part of the screen (area A3 or contact position P3) opposite from the area A2, enabling selection alternately with the thumb and with the other finger. Selecting from the list of albums in the area A3 (contact position P3) invokes a display of the titles of the songs in the selected album in a peripheral part of the screen (area A4 or contact position P4) opposite from the area A3, thereby enabling selection alternately with the thumb and with the other finger. This manner of selecting alternately with the thumb and with another finger enables the user to select a series of menu items to sequentially move down to a hierarchically lower level through the hierarchically structured menus and submenus.

The terminal device 10 may be configured so that the user can proceed to a next page or move down sequentially through the list by touching the “1,” area on the bottom of each list.

The terminal device 10 may be configured so that the user can return to the initial screen of the list of artists, the list of albums, and the list of song titles by touching the “Artist,” “Album,” or “Song Title” areas respectively.

### Effects

Each of these modes displays operation menus on the periphery of the screen to enable inputs on the edge. That in turn prevents the display contents on the screen (e.g., information on the song being played and the list of songs) from being hidden behind displayed keys and fingers, thereby ensuring visibility. The modes also allow for selection of a key on the edge of the screen. That can reduce wrong inputs (wrong button operations) over cases where small input keys are crammed on the screen, thereby improving operability.

### Embodiment 3: Operation Example 3 for Terminal Device 10

Operation examples for the terminal device 10 in accordance with Embodiment 3 will be described in reference to FIGS. 9 to 13. FIG. 9 shows an operation example of an email or other text (Japanese language) input application. Portion (a) of FIG. 9 shows the terminal device 10 displaying an initial screen (vowel keys). Portion (b) of FIG. 9 shows the terminal device 10 displaying a text input screen or responding to the user's subsequent actions. Portion (c) of FIG. 9 shows the terminal device 10 displaying a list of addresses or responding to the user's subsequent actions.

Portions (a) and (b) of FIG. 9 show an exemplary mode of text input operation. Vowels are displayed in the first touch position (edge; contact position P1 in the area A1). If the user selects a character, for example “ [symbol] ”, by touching on the character, candidate characters (candidate consonants or menu items) belonging to the column starting with “ [symbol] ” are displayed in the area A2 across from the first touch position. The vowel characters are not necessarily displayed on the left side of the periphery, but displayed on a side where the first tapping is made. A vowel character may be selected by tapping (brief press and release) on the character. Alternatively, as the finger touches and slides over vowel characters, candidate consonants associated with the vowel character being touched on may be momentarily displayed. Candidate consonants may be displayed that are associated with the vowel character being displayed where the finger is released after sliding. A consonant character may be selected in a similar manner from candidate consonants by tapping. Alternatively, the consonant character being displayed where the finger is released after sliding may be selected.

Portion (c) of FIG. 9 shows an exemplary mode of contact address input operation. Tapping the contact address field invokes a display of vowels on one side (area A1) and a display of a list of addresses related to the character selected by that touch on the opposite side (area A2). Vowel characters are displayed in response to a tapping operation in the contact address field. Vowel characters are not necessarily displayed on the left side and may be displayed on the side often touched initially as determined from operation history. Vowel characters may be displayed on the left side and then upon a tapping on the right side, moved to the right side. Selection from displayed candidates may be made in the same manner as the selection in the modes shown in portions (a) and (b) of FIG. 9.

FIG. 10 shows an exemplary text input flow in an operation example of an email or other text (Japanese language) input application. Portion (a) of FIG. 10 shows the first character being inputted. Portion (b) of FIG. 10 shows the second character being inputted. Portion (c) of FIG. 10 shows candidate conversions being displayed.

Portions (a) and (b) of FIG. 10 show an exemplary mode of text input operation. In this mode, a candidate vowel is selected by touching on the candidate with the thumb (followed or not followed by releasing), and a consonant is selected (input) by touching on the candidate with another finger. In this operation, a candidate may be selected by a single tapping (brief touch and release). Alternatively, the candidate displayed where the finger is released after sliding may be selected. As further alternatives, a candidate may be selected by a double tapping or by swiping in toward the center of the screen. Alternatively, a candidate may be selected by releasing the thumb while the other finger is still touching.

Candidate conversions (menu items) may be displayed based on inputted characters as shown in portion (c) of FIG. 10. If a vowel is selected with the thumb for the input of a next character after candidate conversions are displayed, the candidate conversions may disappear so that candidate consonants can be displayed.

If there are many candidates like candidate conversions, the user may need to scroll the list or jump to a next page of the list. This is done by the same operation as single tapping and releasing of the finger. Therefore, it is preferable to “input” by double tapping, swiping into the screen, or releasing the thumb off the screen. Alternatively, if after a candidate conversion is tentatively selected by single tapping or releasing the finger, “scroll/next page” is touched on again in the right peripheral side, the tentatively selected candidate conversion may be deselected to allow subsequent operations. If an operate is done on the thumb side to input a next character after a candidate conversion is tentatively selected, the tentatively selected candidate conversion may be “inputted.”

FIG. 11 shows an operation example of an email or other English text input application. Portion (a) of FIG. 11 shows the first letter being inputted. Portion (b) of FIG. 11 shows the second letter being inputted. Portion (c) of FIG. 11 shows candidate conversions being displayed.

Portions (a) and (b) of FIG. 11 show an exemplary mode of text input operation. In this mode, candidates that consist of 3 to 4 alphabet letters are displayed on the thumb side (area A1) so that candidates corresponding to the candidate touched on with the thumb (first finger) (contact position P1) can be displayed progressively on a letter-by-letter basis on the other finger's side (second finger side; area A2). Selection (input) on the other finger's side can be made in the same manner as the selection in the modes shown in FIG. 10. A candidate may be selected by a single tapping (brief touch and release). Alternatively, the candidate displayed where the finger is released after sliding may be selected. As further alternatives, a candidate may be selected by a double tapping or by swiping in toward the center of the screen. Alternatively, a candidate may be selected by releasing the thumb while the other finger is still touching.

Next, input candidates (menu items), each being a single word, may be displayed as shown in portion (c) of FIG. 11. The candidates are displayed and selected (inputted) in the same manner as in the mode shown in FIG. 10. When the user continuously inputs letters without selecting from input candidates, the input candidates may disappear from the display in response to a touch on a next candidate letter on the thumb side so that candidate consonants that correspond to the touch with the thumb can be displayed on the right peripheral side.

FIG. 12 shows another operation example of an email or other English text input application. Portions (a) and (b) of FIG. 12 show operation examples in which candidates are displayed on both sides of the display unit 3. Portions (c) and (d) of FIG. 12 show operation examples in which each alphabetic key appears on either side of the display unit 3.

In the mode shown in portions (a) and (b) of FIG. 12, alphabet letters are displayed in groups of 3 to 4 letters on the thumb side (area A1) and the other finger's side (area A2). Each candidate letter in the group that is first touched on is then displayed separately on the opposite side (area A2). In the present embodiment, the alphabet letters, when initially displayed in groups of 3 to 4, are arranged in the QWERTY keyboard layout, but may be arranged in alphabetical order.

Portions (c) and (d) of FIG. 12 show an exemplary mode in which each alphabetic key appears on either side of the display unit 3. This layout enables an input with a single touch. Input word candidates may be displayed on the opposite side during a text input operation. In such cases, if the user inputs a next letter without selecting from input word candidates, the input candidates may disappear from the display in response to a touch on “x” that sits on top of the input candidates so that initial alphabet letter keys can be displayed. In the present embodiment, the alphabet letters are arranged with the QWERTY keyboard layout, but may be arranged in alphabetical order.

FIG. 13 shows a further operation example of an email or other English text input application. This is an example in which all alphabet letters appear on one side in an English text input operation so that the candidates (menu items) prepared by predicting subsequently inputted letters and words can be displayed on the opposite side.

Portions (a) and (b) of FIG. 13 show an example in which all alphabet letters appear on one side (area A1) so that the candidates prepared by predicting subsequently input letters in accordance with the letter selected on that side (area A1) can be displayed on the opposite side (area A2).

In response to the input of the first letter on the thumb side (first finger side or area A1), letters that are likely to follow are selectively displayed on the opposite side (area A2) for selection with another finger (second finger). If there is no candidate, the user can input another letter on the thumb side. Subsequent input letter candidates may be displayed only on the other finger's side or alternately on the thumb side and on the other finger's side.

Portions (c) and (d) of FIG. 13 show an example in which input words are predicted in accordance with the letter selected on one side (area A1) so that candidates can be displayed on the opposite side (area A2).

In response to the input of the first letter on the thumb side (first finger side or area A1), letters that are likely to follow are selectively displayed on the opposite side (area A2) for selection with another finger (second finger). If there is no candidate, the user can input another letter on the thumb side.

The mode shown in portions (a) and (b) of FIG. 13 and the mode shown in portions (c) and (d) of FIG. 13 may be combined so that candidate letters can be displayed in the former mode when only a few letters have been inputted, and as some predicted words become available, the mode may be switched to display those words.

Input letters and words can be predicted, for example, by preparing, in advance, dictionary data containing frequently used common words and retrieving candidates from that data or by presenting candidates based on the user's input history.

### Effects

Each of these modes displays letter input keys on the periphery of the screen of the display unit 3 to enable manipulation of the keys on the edge. That in turn prevents the display contents (email body) on the screen from being hidden behind displayed keys and fingers, thereby ensuring visibility. The modes also allow for selection of a key on the edge of the screen. That can reduce wrong inputs (wrong button operations) over cases where small input keys are crammed on the screen, thereby improving operability.

### Embodiment 4: Operation Example 4 for Terminal Device 10

Operation examples for the terminal device 10 in accordance with Embodiment 4 will be described in reference to FIG. 14 which shows operation examples of a Web browser application. Portion (a) of FIG. 14 shows an initial screen (menu display). As shown in portion (a) of FIG. 14, the initial screen shows a main menu containing icons (menu items) such as “Page Operation,” “Scaling,” “Bookmarks,” and “Select Tab” on the left side (area A1). In response to a touch on an item, a submenu related to the item touched on is displayed on the opposite side (area A2).

Portion (b) of FIG. 14 shows a display or operation example of a page scroll operation. In “Page Operation,” a manipulation bar may be displayed for page scrolling so that the pages can be successively scrolled up or down in response to a finger sliding in the direction indicated by an arrow from the position where the finger has first touched the area A2. The scrolling speed may be increased depending on the distance by which the finger is slid.

Portion (c) of FIG. 14 shows a display or operation example of a scaling operation. In “Scaling,” a manipulation bar may be displayed for scaling so that the scale can be controlled by touching on and then sliding a cursor over the indicator. It is also contemplated that sliding the finger out of the list may invoke switching to a next page.

Portion (d) of FIG. 14 shows a display or operation example for bookmarks. In “Bookmarks,” a list of bookmarks may be displayed to enable selection by touching (tapping). It is also contemplated that a list displayed where the finger is released after touching and sliding can be selected. It is further contemplated that sliding the finger out of the list can invoke switching to a next page.

### Effects

Each of these examples displays operation menus on the periphery of the screen of the display unit 3 to enable operations on the edge. That in turn prevents the display contents on the screen (Web pages) from being hidden behind displayed keys and fingers, thereby ensuring visibility. The examples also allow for selection of a key on the edge of the screen. That can reduce wrong inputs (wrong button operations) over cases where small input keys are crammed on the screen, thereby improving operability.

### Variation Examples of Display Items in Menus

Variation examples of display items (menu items) in the main menu and submenus will be described in reference to FIGS. 15 and 16. The applications that can run on the terminal device 10 are by no means limited to those described in the above embodiments. Various applications shown in FIGS. 15 and 16 can also run on the terminal device 10. In the modes shown in FIGS. 15 and 16, the main menu is displayed on a side touched first after the start of an application. In response to a selection of an item in the main menu, a submenu 1 is displayed on the opposite side. Then, in response to a selection of an item in the submenu 1, a submenu 2 is displayed on the side opposite from the submenu 1 (or on the same side as the submenu 1).

### Software Implementation

The control blocks of the terminal device 10 (particularly, the detection unit controller 21, the setup unit 22, and the display control unit 23) may be implemented with logic circuits (hardware) fabricated, for example, on an integrated circuit (IC chip) and may be implemented by software running on a CPU (central processing unit).

In the latter case, the terminal device 10 includes among others a CPU that executes instructions from programs or software by which various functions are implemented, a ROM (read-only memory) or like storage device (referred to as a “storage medium”) containing the programs and various data in a computer-readable (or CPU-readable) format, and a RAM (random access memory) into which the programs are loaded. The computer (or CPU) retrieves and executes the programs contained in the storage medium, thereby achieving the object of the present invention. The storage medium may be a “non-transient, tangible medium” such as a tape, a disc, a card, a semiconductor memory, or programmable logic circuitry. The programs may be supplied to the computer via any transmission medium (e.g., over a communications network or by broadcasting waves) that can transmit the programs. The present invention encompasses data signals on a carrier wave that are generated during electronic transmission of the programs.

### Overview

The input device (the terminal device 10) in accordance with aspect 1 of the present invention is directed to an input device for receiving an input from a user on an outer edge of a casing of the input device, the input device including: a detection unit (1) configured to detect a contact position of a first finger of the user on the outer edge; and a second setup unit (setup unit 22) configured to set up, by using as a reference a position opposite from the contact position of the first finger of the user detected by the detection unit, a second input area where an input made with a second finger of the user is received.

According to this configuration, the second input area for the second finger is set up across from the contact position of the first finger of the user on the outer edge of the casing. That in turn can improve operability in an input operation that involves use of two or more fingers.

The input device in accordance with aspect 2 of the present invention may further include a first setup unit (setup unit 22) configured to set up, in or near the contact position of the first finger detected by the detection unit in aspect 1, a first input area where an input made with the first finger is received. According to this configuration, an input made with the first finger can also be received as well as an input made with the second finger. Therefore, two or more inputs can be received.

The input device in accordance with aspect 3 of the present invention may be configured so that in aspect 2, the first setup unit and the second setup unit alternately set up the first input area and the second input area respectively. That can improve operability in an input operation that involves use of two or more fingers.

The input device in accordance with aspect 4 of the present invention may be configured so that in aspect 2 or 3, a slide operation or a scroll operation with the second finger is enabled in the second input area while the first finger is touching the first input area. According to this configuration, operability can be improved in an input operation that involves use of two or more fingers.

The input device in accordance with aspect 5 of the present invention may further include, in aspect 2, a display control unit (23) configured to cause a first input-use image prompting the user to make an input in the first input area with the first finger to be displayed in or near the first input area. According to this configuration, the first input-use image is displayed in or near the first input area. That in turn enables the user to visually recognize the first input-use image so that the user can make an input in the first input area while visually recognizing that image.

The input device in accordance with aspect 6 of the present invention may be configured so that in aspect 5, the display control unit is further configured to cause a second input-use image prompting the user to make an input in the second input area with the second finger to be displayed in or near the second input area in response to an input in the first input area.

According to this configuration, the second input-use image is displayed in or near the second input area in response to an input in the first input area. That in turn enables the user to visually recognize the second input-use image upon that input so that the user can make an input in the second input area while visually recognizing that image.

In addition, the second input-use image is not displayed in or near the second input area until an input made in the first input area. Therefore, the user cannot recognize the presence of the second input area before making an input in the first input area. In other words, the user cannot make an input in the second input area before making an input in the first input area. Thus, no input is allowed in the second input area while the user is making an input in the first input area. The configuration can hence prevent malfunctions that could be caused if inputs are permitted in more than one location.

The input device in accordance with aspect 7 of the present invention may be configured so that in aspect 6: the second input-use image includes a plurality of menu items; and in response to the second finger being released off the second input area when the second finger is being slid over the second input area, a menu item associated with a position where the second finger is released is selected. According to this configuration, operability can be improved in an input operation that involves use of two or more fingers.

The input device in accordance with aspect 8 of the present invention may be configured so that in aspect 6: the second input-use image includes a plurality of menu items; and in response to the first finger being released off the first input area when the first finger is touching the first input area and the second finger is touching the second input area, a menu item associated with a position where the second finger is touching the second input area is selected. According to this configuration, operability can be improved in an input operation that involves use of two or more fingers.

The input device in accordance with aspect 9 of the present invention may further include, in aspect 2, a display control unit configured to cause a first input-use image prompting the user to make an input in the first input area with the first finger to be displayed in or near the first input area and further configured to cause a second input-use image prompting the user to make an input in the second input area with the second finger to be displayed in or near the second input area in response to an input in the first input area, wherein the first input-use image and the second input-use image are alternately displayed if the detection unit alternately detects the contact position of the first finger and a contact position of the second finger. According to this configuration, the first input-use image and the second input-use image are alternately displayed by making an input alternately in the first finger and in the second finger. That in turn enables the user to visually recognize the first input-use image and the second input-use image alternately upon such inputs so that the user can make an input alternately in the first input area and in the second input area while visually recognizing those images, which can improve operability in an input operation that involves use of two or more fingers.

The input device in accordance with aspect 10 of the present invention may be configured so that in aspect 6, the second input-use image includes a submenu associated with a main menu shown in the first input-use image prompting the user to make an input in the first input area with the first finger. According to this configuration, a submenu is displayed in or near the second input area, which is triggered by the input in the first input area with the first finger as prompted by the main menu. That can improve the visibility of the menus and the operability of the input device.

The input device in accordance with aspect 11 of the present invention may be configured so that in aspect 9, the display control unit is configured to cause hierarchically lower-level submenus to be displayed in accordance with a sequence in which the first input-use image and the second input-use image are alternately displayed. This configuration enables selection of menu items in hierarchically lower-level submenus in accordance with the sequence in which the first input-use image and the second input-use image are alternately displayed, which can improve operability in an input operation that involves use of two or more fingers.

The input device in accordance with aspect 12 of the present invention may be configured so that in any of aspects 1 to 11, the detection unit is stacked on a display unit in the casing to detect a target object touching or approaching a display screen of the display unit and also detect the first finger or the second finger touching or approaching the outer edge. This configuration enables the detection unit, which is stacked on the display unit in the casing and which also detects a target object touching or approaching the display screen of the display unit, to detect the first or the second finger touching or approaching the outer edge. Therefore, no new detection member needs to be provided to detect touching or approaching of the outer edge. That in turn can reduce the parts count.

The input device in accordance with aspect 13 of the present invention may be configured so that in any of aspects 1 to 11, the detection unit is disposed on a side face of the casing. This configuration enables the detection unit, disposed on a side face of the casing, to detect the first or the second finger touching or approaching the outer edge.

A wearable terminal in accordance with aspect 14 of the present invention preferably includes the input device in any of aspects 1 to 13. This configuration provides a wearable terminal that can improve operability in an input operation that involves use of two or more fingers.

A mobile terminal in accordance with aspect 15 of the present invention preferably includes the input device in any of aspects 1 to 13. This configuration provides a mobile terminal that can improve operability in an input operation that involves use of two or more fingers.

A method of controlling an input device in accordance with aspect 16 of the present invention is directed to a method of controlling an input device for receiving an input from a user on an outer edge of a casing of the input device, the method includes: (a) detecting a contact position of a first finger of the user on the outer edge; and (b) setting up, by using as a reference a position opposite from the contact position of the first finger detected in step (a), a second input area where an input made with a second finger of the user is received. This method achieves the same effects as aspect 1.

A control program for an input device in accordance with aspect 17 of the present invention may be directed to a control program for controlling an operation of an input device in aspect 1, the control program causing a computer to operate as the second setup unit in the input device.

### Additional Remarks

The input device in each aspect of the present invention may be implemented on a computer. When this is the case, the present invention encompasses programs, for controlling the input device, which when run on a computer cause the computer to function as those units in the input device (only software elements) to implement the input device and also encompasses computer-readable storage media containing such a program.

The present invention is not limited to the description of the embodiments above, but may be altered within the scope of the claims. An embodiment based on a proper combination of technical means disclosed in different embodiments is encompassed in the technical scope of the present invention. Furthermore, new technological features can be created by combining technological means disclosed in different embodiments.

### INDUSTRIAL APPLICABILITY

The present invention is applicable, for example, to input devices receiving user inputs on an outer edge of the casing thereof, wearable terminals including such an input device, and mobile terminals including such an input device.

### REFERENCE SIGNS LIST

1 Detection Unit
3 Display Unit
10 Terminal Device (Input Device, Wearable Terminal, Mobile Terminal)
11 Touch Panel (Detection Unit)
12 Side Face Touch Sensor (Detection Unit)
22 Setup Unit (First Setup Unit, Second Setup Unit)
23 Display Control Unit
P1 to P4 Contact Position

1. An input device for receiving an input from a user on an outer edge of a casing of the input device, the input device comprising:
a detection unit configured to detect a contact position of a first finger of the user on the outer edge; and
a second setup unit configured to set up, by using as a reference a position opposite from the contact position of the first finger of the user detected by the detection unit, a second input area where an input made with a second finger of the user is received.

2. The input device according to claim 1, further comprising a first setup unit configured to set up, in or near the contact position of the first finger detected by the detection unit, a first input area where an input made with the first finger is received.

3. The input device according to claim 2, wherein the first setup unit and the second setup unit alternately set up the first input area and the second input area respectively.

4. The input device according to claim 2 or 3, wherein a slide operation or a scroll operation with the second finger is enabled in the second input area while the first finger is touching the first input area.

5. The input device according to claim 2, further comprising a display control unit configured to cause a first input-use image prompting the user to make an input in the first input area with the first finger to be displayed in or near the first input area.

6. The input device according to claim 5, wherein the display control unit is further configured to cause a second input-use image prompting the user to make an input in the second input area with the second finger to be displayed in or near the second input area in response to an input in the first input area.

7. The input device according to claim 6, wherein:
the second input-use image includes a plurality of menu items; and
in response to the second finger being released off the second input area when the second finger is being slid over the second input area, a menu item associated with a position where the second finger is released is selected.

8. The input device according to claim 6, wherein:
the second input-use image includes a plurality of menu items; and
in response to the first finger being released off the first input area when the first finger is touching the first input area and the second finger is touching the second input area, a menu item associated with a position where the second finger is touching the second input area is selected.

9. The input device according to claim 2, further comprising a display control unit configured to cause a first input-use image prompting the user to make an input in the first input area with the first finger to be displayed in or near the first input area and further configured to cause a second input-use image prompting the user to make an input in the second input area with the second finger to be displayed in or near the second input area in response to an input in the first input area, wherein the first input-use image and the second input-use image are alternately displayed if the detection unit alternately detects the contact position of the first finger and a contact position of the second finger.

10. The input device according to claim 6, wherein the second input-use image comprises a submenu associated with a main menu shown in the first input-use image prompting the user to make an input in the first input area with the first finger.

11. The input device according to claim 9, wherein the display control unit is configured to cause hierarchically lower-level submenus to be displayed in accordance with a sequence in which the first input-use image and the second input-use image are alternately displayed.

12. The input device according to any one of claims 1 to 11, wherein the detection unit is stacked on a display unit in the casing to detect a target object touching or approaching a display screen of the display unit and also detect the first finger or the second finger touching or approaching the outer edge.

13. The input device according to any one of claims 1 to 11, wherein the detection unit is disposed on a side face of the casing.

14. A wearable terminal, comprising an input device according to any one of claims 1 to 13.

15. A mobile terminal, comprising an input device according to any one of claims 1 to 13.

16. A method of controlling an input device for receiving an input from a user on an outer edge of a casing of the input device, the method comprising:
(a) detecting a contact position of a first finger of the user on the outer edge; and
(b) setting up, by using as a reference a position opposite from the contact position of the first finger detected in step (a), a second input area where an input made with a second finger of the user is received.

17. A control program for controlling an operation of an input device according to claim 1, the control program causing a computer to operate as the second setup unit.
